(19) United States
(12) Patent Application Publication
(10) Pub. No.: US 2023/0108001 A1
(43) Pub. Date: Apr. 6, 2023

(54) PRIORITY-BASED SCHEDULING WITH LIMITED RESOURCES

(71) Applicant: ADVANCED MICRO DEVICES, INC., Santa Clara, CA (US)

(72) Inventor: Daniel Waihim WONG, Santa Clara, CA (US)

(21) Appl. No.: 17/486,226

(22) Filed: Sep. 27, 2021

(51) Int. Cl. G06F 9/48

(52) U.S. Cl. CPC G06F 9/4881

(57) ABSTRACT

Priority-based scheduling a limited processing resource is disclosed. In an embodiment, a resource manager receives information from a workload initiator describing characteristics of a workload to be executed, determines a priority level for the workload based on the characteristics of the workload and one or more policies, and associates the priority level with the workload. A job scheduler receives a priority assignment for the workload from the resource manager and schedules execution of the workload on hardware resources based on the priority level.

### BACKGROUND

Computing systems often include a number of processing resources (e.g., one or more processors), which can retrieve and execute instructions and store the results of the executed instructions to a suitable location or output a computational result. Applications executing on such computer systems can be given the opportunity select a particular processing resource to execute a specific workload. For example, in a computing system that includes a central processing unit (CPU) and one or more accelerated processing devices such as graphics processing units (GPUs), the application can select a specific processor to execute an application workload. An application can determine what processing resources are resident in the computing system by querying the operating system of the computing system. In one example, a multimedia playback application can query the operating system for a list of devices capable of media playback and select, for example, a particular GPU for execution a video playback workload.

### BRIEF DESCRIPTION OF THE DRAWINGS

FIG. 1 sets forth a block diagram of an example system for priority-based scheduling with limited resources in accordance with some implementations of the present disclosure.

FIG. 2 sets forth a flow chart illustrating an example method of priority-based scheduling with limited resources in accordance with some implementations of the present disclosure.

FIG. 3 sets forth a flow chart illustrating an example method of priority-based scheduling with limited resources in accordance with some implementations of the present disclosure.

FIG. 4 sets forth a flow chart illustrating an example method of priority-based scheduling with limited resources in accordance with some implementations of the present disclosure.

FIG. 5 sets forth a flow chart illustrating another example method of priority-based scheduling with limited resources in accordance with some implementations of the present disclosure.

FIG. 6 sets forth a flow chart illustrating another example method of priority-based scheduling with limited resources in accordance with some implementations of the present disclosure.

FIG. 7 sets forth a flow chart illustrating another example method of priority-based scheduling with limited resources in accordance with some implementations of the present disclosure.

FIG. 8 sets forth a flow chart illustrating another example method of priority-based scheduling with limited resources in accordance with some implementations of the present disclosure.

### DETAILED DESCRIPTION

In some scenarios, when an application is ready to assign a workload for execution, the application first queries the operating system to determine what processing resources are available. For example, if the workload is a graphics (e.g., graphics rendering for gaming) or multimedia workload (e.g., multimedia playback), the application can first determine whether a graphics processing unit (GPU) is present in the computing device. In some computing devices, there can be more than one GPU present. For example, the computing device can include an integrated central processing unit (CPU) and GPU while also including a discrete GPU (i.e., on a separate chip). Furthermore, the application can determine, for example, what video codecs are supported by the GPUs to determine where the workload can be placed. For example, a streaming media service player can describe a particular workload (e.g., a movie) in terms of source resolution, bit rate, codecs, display resolution, frame rate, and the like. The streaming media service player can then query the operating system for processor resources capable of executing the workload. The operating system can respond by identifying the GPUs that have the ability to execute the workload. Based on the operating system’s response, the application can select a GPU and assign the workload to that GPU. For example, the application can assign the workload to the integrated GPU because the integrated GPU typically consumes less power than the discrete GPU. This can be of particular concern when the computing device is operating on battery power.

When the operating system provides the information about the capabilities of the computing device, however, it does so without any insight as to the runtime behavior of the system. That is, the operating system does not know how busy the video codec of the integrated GPU is. If the application decides to place the workload on the integrated GPU, which can also be running other video workloads such a video conferencing application, the video codec of the integrated GPU can become oversubscribed. In other words, the application and the operating system do not have visibility as to the real runtime utilization of processor resources, and thus do not know if computing device will be able to deliver the user experience expected for the workload.

Furthermore, when the application places a particular workload on a hardware resource, the job scheduler for that hardware resource is unaware that the particular workload should be given priority over any other workloads. For example, the job scheduler cannot distinguish between a real-time workload that is critical (e.g., display rendering) and a workload that can be executed opportunistically in the background. In particular, a job scheduler for a limited resource such as a video encoder/decoder has a limited context for scheduling a workload.

To address these limitations, the present disclosure provides a mechanism for a priority-based resource scheduling in which a workload is associated with a priority assignment based on workload characteristics. For example, real-time workloads and non-real-time workloads can be assigned distinct priority levels, which can be used by a job scheduler to provide hardware access for the workload based on the assigned priority.

To that end, an embodiment is directed to a method of priority-based scheduling with limited resources. The method includes receiving information from a workload initiator describing characteristics of a workload to be executed. The method also includes determining, based on the characteristics of the workload and one or more policies, a priority level for the workload. The method further includes associating the priority level with the workload. In some implementations, the priority level corresponds to one or more quality of service (QoS) levels based on a user experience objective.

In some implementations, determining, based on the characteristics of the workload and one or more policies, a priority level for the workload includes identifying, based on the characteristics of the workload, a job classification for the workload. In these implementations, determining the priority level also includes identifying, from the one or more policies, a priority definition corresponding to the job classification.

In some implementations, the method also includes identifying a processing resource capable of executing at least part of the workload. In these implementations, the method also includes communicating, to a job scheduler for the processing resource, a priority assignment for the workload that indicates the priority level. In some examples, the processing resource is a decoding/encoding accelerator (i.e., a codec).

In some implementations, receiving information from a workload initiator describing characteristics of the workload to be executed includes receiving, from the workload initiator, a request for a workload allocation recommendation. In these implementations, identifying a processing resource capable of executing at least part of the workload includes determining, based on utilization metrics of a plurality of processing resources, a recommended workload allocation that includes the processing resource.

In some implementations, the method also includes receiving, by a job scheduler, the priority level associated with the workload. In these implementations, the method also includes scheduling execution of the workload based on the priority level. In some examples, scheduling execution of the workload based on the priority level includes assigning the workload to a job scheduling queue among a plurality of job scheduling queues each corresponding to a priority level. In some examples, scheduling execution of the workload based on the priority level includes preempting a first workload having a first priority level for a second workload having a second priority level, wherein the second priority level is a higher priority than the first priority level.

A variation of the embodiment is directed to an apparatus for priority-based scheduling with limited resources. The apparatus includes a computer processor and a computer memory operatively coupled to the computer processor. The computer memory has disposed therein computer program instructions that, when executed by the computer processor, cause the apparatus to receive information from a workload initiator describing characteristics of a workload to be executed. The instructions also cause the apparatus to determine, based on the characteristics of the workload and one or more policies, a priority level for the workload. The instructions also cause the apparatus to associate the priority level with the workload. In some implementations, the priority level corresponds to one or more quality of service (QoS) levels based on a user experience objective.

In some implementations, determining, based on the characteristics of the workload and one or more policies, a priority level for the workload includes identifying, based on the characteristics of the workload, a job classification for the workload. In these implementations, determining the priority level also includes identifying, from the one or more policies, a priority definition corresponding to the job classification.

In some implementations, the apparatus includes computer program instructions that, when executed, cause the apparatus to identify a processing resource capable of executing at least part of the workload. In these implementations, the instructions further cause the apparatus to communicate, to a job scheduler for the processing resource, a priority assignment for the workload that indicates the priority level.

In some implementations, the apparatus includes computer program instructions that, when executed, cause the apparatus to receive, by a job scheduler, the priority level associated with the workload and schedule execution of the workload based on the priority level. In some examples, scheduling execution of the workload based on the priority level includes assigning the workload to a job scheduling queue among a plurality of job scheduling queues each corresponding to a priority level.

Another variation of the embodiment is directed to a computer program product for priority-based scheduling with limited resources. The computer program product is disposed upon a computer readable medium and comprises computer program instructions that, when executed, cause a computer to receive information from a workload initiator describing characteristics of a workload to be executed. The instructions also cause the computer to determine, based on the characteristics of the workload and one or more policies, a priority level for the workload. The instructions also cause the computer to associate the priority level with the workload.

In some implementations, determining, based on the characteristics of the workload and one or more policies, a priority level for the workload includes identifying, based on the characteristics of the workload, a job classification for the workload. In these implementations, determining the priority level also includes identifying, from the one or more policies, a priority definition corresponding to the job classification.

In some implementations, the computer program product includes computer program instructions that, when executed, cause the computer to identify a processing resource capable of executing at least part of the workload. In these implementations, the instructions further cause the computer to communicate, to a job scheduler for the processing resource, a priority assignment for the workload that indicates the priority level.

In some implementations, the computer program product includes computer program instructions that, when executed, cause the computer to receive, by a job scheduler, the priority level associated with the workload and schedule execution of the workload based on the priority level. In some examples, scheduling execution of the workload based on the priority level includes assigning the workload to a job scheduling queue among a plurality of job scheduling queues each corresponding to a priority level.

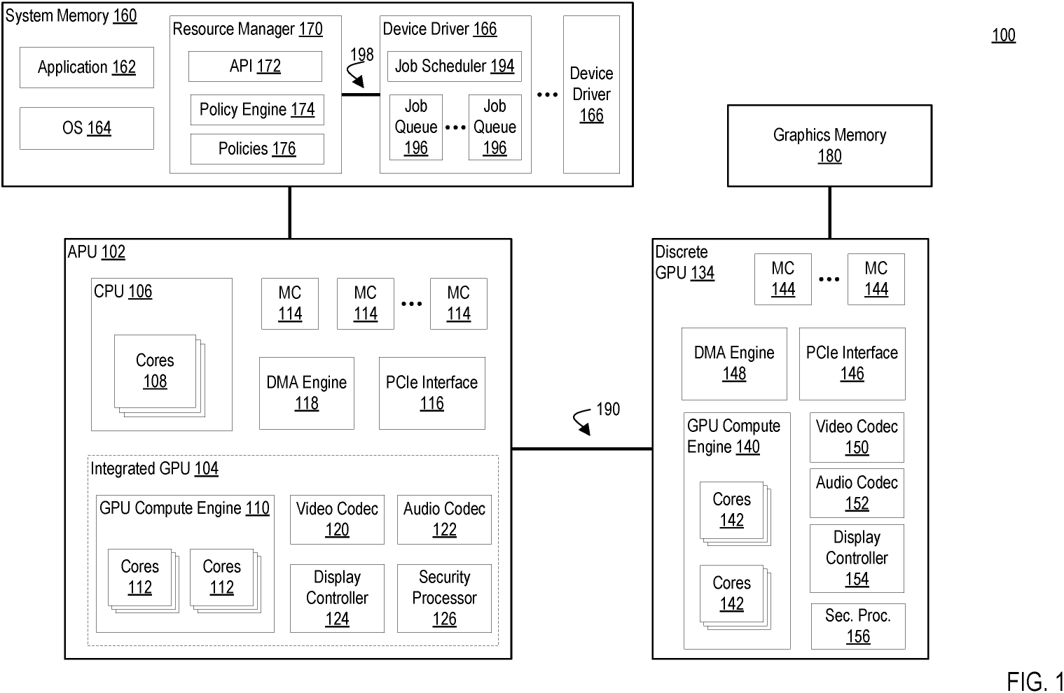

An embodiment in accordance with the present disclosure will be described in further detail beginning with FIG. 1. Like reference numerals refer to like elements throughout the specification and drawings. FIG. 1 sets forth a block diagram of an example system 100 for providing an optimized service-based pipeline in accordance with implementations of the present disclosure. The example system 100 of FIG. 1 can be implemented in a computing device such as a laptop or desktop personal computer, a server, a mobile device such as a smart phone or tablet, a gaming console, and so on. The example system 100 includes two graphics processing units (GPUs) 104, 134, although it will be appreciated by those of skill in the art that other systems can include more GPUs, or can use other types of accelerated processing devices, without departing from the spirit of the present disclosure.

In the example of FIG. 1, the example system 100 includes an accelerated processing unit (APU) that integrates a central processing unit (CPU) 106 and a GPU 104 (referred to herein as an “integrated GPU”). The CPU 106 and the integrated GPU 104 can be implemented on the same chip and thus can share a number of components and interfaces such as system memory 160, memory controllers 114 and direct memory addressing (DMA) engines 118 for accessing system memory 160, bus interfaces such as a personal computing interface express (PCIe) interface 116, and other interfaces and adapters not depicted in FIG. 1 such as network interfaces, universal serial bus (USB) interfaces, persistent storage interfaces such as hard disk drive (HDD) or solid state drive (SSD) interface, and so on. The CPU 106 includes one or more cores 108 (i.e., execution engines), cache structures (not shown), pipeline components (also not shown), and so on. The CPU 106 and other shared components are connected to the GPU 104 via a high-speed on-chip communications fabric (not shown).

In the example system 100 of FIG. 1, the integrated GPU 104 includes a GPU compute engine 110 that includes multiple single instruction multiple data (SIMD) processing cores 112 having many parallel processing units (not shown). The GPU compute engine 110 can also include other components not depicted in FIG. 1 such as geometry processors, rasterizers, graphic command processors, hardware schedulers, asynchronous compute engines, caches, data shares, and so on. In the example of FIG. 1, the integrated GPU 104 also includes hardware accelerators in the form of application specific integrated circuits or functional logic blocks such as a video encoder/decoder 120 (i.e., a “codec”) for accelerated video encoding and decoding, an audio codec 122 for accelerated audio encoding and decoding, a display controller 124 for accelerated display processing, and a security processor 126 for accelerated security protocol enforcement and compliance.

In the example of FIG. 1, the APU 102 communicates with a discrete GPU 134 over an interconnect such as a PCIe interconnect 190. The PCIe interface 116 of the APU 102 and a PCIe interface 146 of the discrete GPU 134 communicate over the PCIe interconnect 190. In some examples, the APU 102 and the discrete GPU 134 are located on the same substrate (e.g., a printed circuit board). In other examples, the discrete GPU 134 is located on a video or graphics card that is separate from the substrate of the APU 102.

Like the integrated GPU 104, the discrete GPU 134 in the example of FIG. 1 includes a GPU execution engine 140 that includes multiple SIMD processing cores 142 having many parallel processing units (not shown). The GPU execution engine 140 can also include other components not depicted in FIG. 1 such as geometry processors, rasterizers, graphic command processors, hardware schedulers, asynchronous compute engines, caches, data shares, and so on. In the example of FIG. 1, the discrete GPU 134 also includes hardware accelerators in the form of application specific integrated circuits or functional logic blocks such as a video encoder/decoder 150 (i.e., a “codec”) for accelerated video encoding and decoding, an audio codec 152 for accelerated audio encoding and decoding, a display controller 154 for accelerated display processing, and a security processor 156 for accelerated security protocol enforcement and compliance. The discrete GPU 134 also includes memory controllers 144 and DMA engines 148 for accessing graphics memory 180. In some examples, the memory controllers 144 and DMA engines 148 are configured to access a shared portion of system memory 160.

In the example system 100 of FIG. 1, the system memory 160 (e.g., dynamic random access memory (DRAM)) hosts an operating system 164 that interfaces with device drivers 166 for the processor resources (i.e., the APU and discrete GPU and their constituent components) described above. The system memory 160 also hosts one or more applications 162. Pertinent to this disclosure, the one or more applications can be graphics applications, multimedia applications, video editing applications, video conferencing applications, high performance computing applications, machine learning applications, or other applications that take advantage of the parallel nature and/or graphics and video capabilities of the integrated GPU 104 and the discrete GPU 134. The one or more applications 162 generate workloads (e.g., graphics rendering workloads, audio/video transposing workload, media playback workload, machine learning workloads, etc.) that are allocated to the integrated GPU 104 or the discrete GPU 134 (or a combination of both) by a call to the operating system 164. Readers of skill in the art will appreciate that the one or more applications can be variety of additional application types generating a variety of workload types, not all of which are identified here. However, the specific mention of application types and workload types within the present disclosure should not be construed as limiting application types and workload types to those that are identified here.

The system memory 160 also hosts a resource manager 170 that receives information describing characteristics of a workload to be executed from a workload initiator, such as the application 162. The resource manager 170 determines, based on the characteristics of the workload and one or more policies, a priority level for the workload. The resource manager 170 associates the priority level with the workload. In some examples, the resource manager 170 is embodied in computer executable instructions that are stored on a tangible computer readable medium and that, when executed by a processor, cause the system 100 to carry out the aforementioned steps, as well as other steps and operations performed by the resource manager 170 that are described below.

In some variations, the resource manager provides a workload allocation recommendation based on the description of the workload. The resource manager 170 inspects, based on the workload description, runtime utilization metrics of a plurality of processor resources including the integrated GPU and the discrete GPU and determines a workload allocation recommendation based on at least the dependence the utilization metrics and one or more policies. In one example, the resource manager 170 includes an API 172 through which an application 162 can request a workload allocation recommendation from the resource manager 170 prior to the application assigning the workload to a particular GPU. The workload allocation recommendation, in this context, is a recommendation as to where (i.e., on which GPU) a workload should be placed (i.e., for execution the workload). The workload allocation recommendation is based on, for example, the workload description, utilization metrics of various processor resources in the system 100, and one or more policies that pertain to the workload or type of workload. In some examples, the resource manager 170 includes a policy engine 174 that interprets one or more policies 176 that are relevant to determining the optimal allocation of the workload to the GPUs 104, 134 based on the current values of runtime utilization metrics of the processor resources. The workload allocation recommendation is then returned to the application 162, which the application 162 uses to decide where to place the workload. In some variations, the resource manager 170 communicates with the drivers 166 to obtain values for utilization metrics or obtains values for utilization metrics by other mechanisms. In such examples, a driver 166 for hardware processing device or firmware in the device itself can include a utilization monitor or other counters and an interface for providing utilization metric values to the resource manager 170.

The resource manager 170 assigns a priority to the workload based on the characteristics of the workload provided in the description of the workload. In some examples, as discussed above, the resource manager can receive the description of the workload from the application 162 when the application requests a workload allocation recommendation, for example via an API call. The resource manager 170 uses one or more policies 176 to determine, for example by the policy engine 174, a priority level that should be assigned to a workload. In one variation, the resource manager 170 assigns a priority to the workload based on a workload type provided in the description of the workload. In this example, the policy identifies a type of workload and a priority level, and incoming workloads having that same workload type are assigned the corresponding priority level. In another variation, rather than receiving an explicit workload type, the workload characteristics (e.g., processing or hardware requirements, compression protocols, bit rate, frame rate, resolution, etc.) are compared to model workload characteristics described in the policy. For example, the policy can include model characteristics for one or more types of workloads and a priority level that should be assigned to a workload that fits in that model. In some implementations, a policy maps particular workload types to a job class. The policy also maps a particular job class to a priority definition. The workload having a workload type that falls within a job class is assigned priority level in accordance with the priority definition for that job class. In one example, a policy indicates that workloads that are characterized as real-time workloads should be assigned a higher priority level and workloads that are characterized as non-real-time workloads should be assigned a lower priority level.

In one example, the resource manager 170 receives information describing the workload from the application 162, for example, as part of a request for a workload allocation recommendation. The resource manager 170 identifies a hardware resource that is part of the workload allocation recommendation, based on the utilization metrics as discussed above, and communicates the priority assignment for the workload to the job scheduler for that hardware resource. Additional details are provided below that discuss operations performed by the resource manager 170 in the context of workload priority assignments for priority-based scheduling.

For each processing resource there is a job scheduler 194 that dispatches workloads for execution on the processing resource. For example, there can be job scheduler for the video codec 120 on the APU 102, a job scheduler for the audio codec 122 on the APU 102, a video codec 150 on the discrete GPU 134, a job scheduler for the audio codec 152 on the discrete GPU 134, and so on. In some implementations, as depicted, the job scheduler 194 is provided in the device driver 166 for the processing resource. The job schedulers 194 receive information from the resource manager 170 about incoming workloads from workload initiators. In one example, the resource manager 170 communicates with the job scheduler 194 through a direct communication path 198 between the driver 166 and the resource manager 170 that does not involve the operating system. The communication path 198 can be used for communicating values of device utilization metrics from the driver 166 to the resource manager 170 and for communicating workload priority assignments from the resource manager 170 to the driver 166. The job scheduler 194 can communicate with firmware included in the hardware resource.

In some implementations, the resource manager 170 provides, to the job scheduler 194, information indicating that a workload initiated by a particular application (i.e., a particular process or thread identifier) has been assigned a particular priority level. The job schedulers 194 use the priority level assignment when scheduling jobs on its corresponding hardware component (e.g., a video codec). In some examples, the job schedulers 194 each interact with multiple job queues 196. While the job queues 196 are illustrated as part of the device driver 166, the implementation of the job queues 196 can be provided partially or completely in the firmware (not shown) of the hardware resource (e.g., video codec 120 or video codec 150, audio codec 122 or audio codec 152, etc.). In some implementations, there is a job queue 196 for each priority level, such that work items of a workload are placed in a job queue 196 that corresponds to the priority level assigned to the workload. Readers of skill in the art will appreciate that a variety of job scheduling techniques can be employed to service each job queue without starving any one job queue while also providing priority scheduling to the priority queues. Additional details are provided below that discuss operations performed by the job scheduler 194, such as receiving a priority level assignment for a workload and handling job scheduling for the workload based on the priority level assignment.

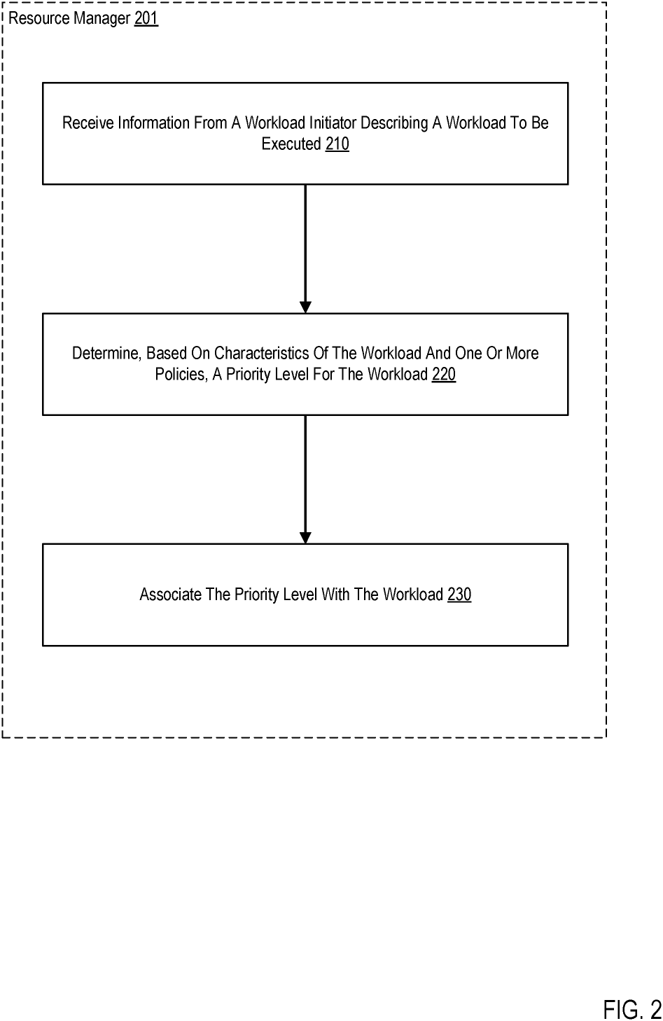

For further explanation, FIG. 2 sets forth a flow chart illustrating an example method of priority-based scheduling with limited resources in accordance with some implementations of the present disclosure. The example method of FIG. 2 includes receiving 210 information from a workload initiator describing characteristics of a workload to be executed. In some implementations, receiving 210 information from a workload initiator describing characteristics of a workload to be executed is carried out by a resource manager 201 (e.g., the resource manager 170 of FIG. 1) of a computing system (e.g., the computing system 100 of FIG. 1) receiving information generated by a workload initiator, such as an application (e.g., the application 162 of FIG. 1), describing a workload that it intends to run on the computing system. In some implementations, an application provides the description of the workload to the resource manager prior to allocating the workload to one or more processing resources (i.e., processors, accelerators, and other computational hardware) for execution. For example, prior to submitting a job request for a particular processing resource to carry out the workload, the application first describes the workload to the resource manager. In one example, the information describing the workload is received as part of a query directed to the capabilities and current utilization of processor resources in the computing system.

Various types of applications can be workload initiators, each with a variety of types of workloads. In some examples, information from the workload initiator includes a process identifier or thread identifier. In some examples, the information describes the type of the application as predefined or otherwise recognizable type of application. For example, the application be identified as a video conferencing application, media playback application, game, video editing application, and so on. In some examples, the information describes the type of the workload as predefined or otherwise recognizable type of workload. For example, the workload can be identified as a streaming media playback workload, a graphics rendering workload, a transcode workload, and so on. In some examples, the information describes workload characteristics such as processing or hardware requirements, protocols or standards, or QoS or performance expectations for the workload. For example, the information describes a video compression standard or protocol, a display resolution, a frame rate, and so on. The information can describe a variety of other characteristics of the workload that are not mentioned above. Characteristics of the workload, such as those mentioned above, are useful in determining a priority level for the workload.

Consider an example where a media player application has a media playback workload that it intends to run on the computing system. In such an example, the information describing the workload can include workload initiator identifier (ID) (e.g., a process ID or a thread ID) of the workload initiator, the workload type (i.e., media playback), the application type, and other characteristics such as video and audio decoding protocols, source resolution, display resolution, bit rate, and frame rate for the playback workload. As another example, a video conversion application can have a transcode workload that is intends to run the computing system. In such an example, the information describing the workload can include the initiator ID, the workload type, the application type, and other characteristics such as source video decoding standard, and target video encoding standard, and a frame rate. As yet another example, a video conferencing application can include an artificial intelligence (AI) workload that includes AI algorithms for gaze correction or removing/substituting a participant’s background on screen. In such an example, the information describing the workload can include the initiator ID, the workload type, the application type, and other characteristics such as the number of compute units needed to execute the AI algorithms.

In some variations, the description of the workload is provided using a descriptive language that is parsable by the resource manager. For example, the descriptive language can include a descriptor tag for bit rate, a descriptor tag for display resolution, a descriptor tag for a video encoding protocol, and so on. In such examples, the description of the workload is a structured description of the workload. In some examples, as will be described in more detail below, the descriptive language included in the request is parsable by a policy engine of the resource manager (e.g., the policy engine 174 of the resource manager 170).

The example method of FIG. 2 also includes determining 220, based on the characteristics of the workload and one or more policies, a priority level for the workload. In some implementations, determining 220a priority level for the workload is carried out by the resource manager 201 analyzing the information describing the workload to determine a workload type. In some variations, the workload type is made explicit in the information describing the workload. For example, the information describing the workload can indicate that the workload is a transcoding workload. In other variations, the workload type is inferred from the workload characteristics such as the video encoding/decoding protocols or audio encoding/decoding protocols used. In still other variations, the workload type is inferred using the identity of the application that initiated the workload. For example, the application name or application description can be identified using a process identifier and a system process registry, and the workload type can be inferred from name or description of the application (or service) that initiated the workload.

In some examples, determining 220, based on the characteristics of the workload and one or more policies, a priority level for the workload is further carried out by determining a priority level for the workload using the workload type and one or more policies. In some examples, one or more policies map a variety of workload types to a priority level for the workload type. For example, where the workload is a video capture workload from a videoconferencing application, the workload type can be designated as ‘video capture,’ where a policy assigns a high priority level (e.g., the highest priority level) to the ‘video capture’ workload type. In another example, where the workload is a transcode workload of a video transcoding application, the workload type can be designated as ‘transcode,’ where a policy assigns a low priority level (e.g., the lowest priority level) to the ‘transcode’ workload type. Thus, in some examples, the priority level for the workload is determined by mapping the workload type characteristic of the workload to a priority level using one or more policies.

The example method of FIG. 2 also includes associating 230 the priority level with the workload. In some implementations, associating 230 the priority level with the workload is carried out by the resource manager 201 inspecting the workload initiator ID (e.g., the process ID or thread ID of the workload initiator application or application thread) and associating the workload initiator ID with the priority level determined for the workload. In some variations, associating the workload initiator ID with the priority level is carried out by storing the process/thread ID and the priority level in a data structure. In some variations, associating 230 the priority level with the workload is carried out by signaling the process/thread ID and priority level to other components such as device drivers, device firmware, the workload initiator application, the operating system, and so on.

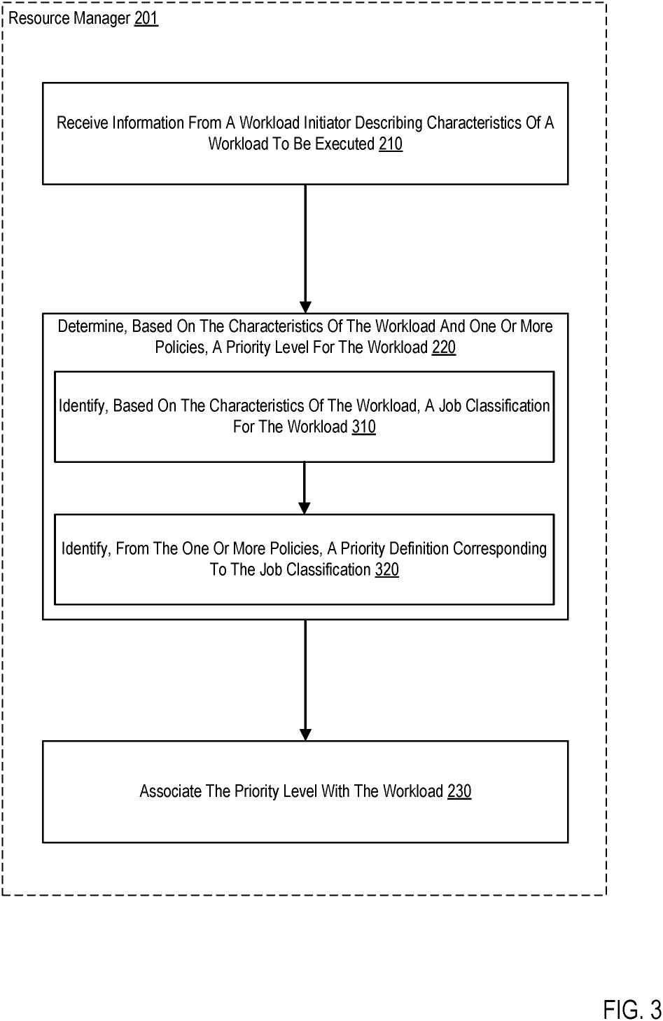

For further explanation, FIG. 3 sets forth a flow chart illustrating an example method of priority-based scheduling with limited resources in accordance with some implementations of the present disclosure. Like the example method of FIG. 2, the example method of FIG. 3 also includes receiving 210 information from a workload initiator describing characteristics of a workload to be executed; determining 220, based on the characteristics of the workload and one or more policies, a priority level for the workload; and associating 230 the priority level with the workload.

In the example method of FIG. 3, determining 220a priority level for the workload includes identifying 310, based on the characteristics of the workload, a job classification for the workload. In some implementations, identifying 310a job classification for the workload is carried out by the resource manager 201 identifying a job classification for the workload based on the workload type. In some examples, a set of job classes is used to classify any workload in accordance with one or more policies based on the workload type. In one example, a workload can be classified as a real-time job, a normal job, or a background job in accordance with policies that map workload types to job classifications. In such an example, a policy can indicate that a workload that includes video capture should be classified as a real-time job, while another policy can indicate that a workload that includes transcoding should be classified as a background job.

In the example method of FIG. 3, determining 220a priority level for the workload also includes identifying 320, from the one or more policies, a priority definition corresponding to the job classification. In some implementations, the policies include priority definitions that map job classifications to priority levels. Thus, one or more policies can include a priority definition for each job classification. In some examples, identifying 320a priority definition corresponding to the job classification is carried out by the resource manager 201 referencing a mapping of the job classification to a priority definition described in a policy. For example, where there are six job classifications, there can be six priority levels respectively corresponding to the six job classifications. Where a workload falls in a job class that is defined as having the highest priority level (e.g., priority level ‘1’), this means that completion of the workload should be prioritized over workloads having a lower priority level. Where a workload falls in a job class that is defined as having the lowest priority level (e.g., priority level ‘6’), this means that completion of all other workloads having a higher priority level should be prioritized over the lowest priority level. In some examples, the priority level corresponds to a QoS level for a user experience objective. In these examples, the user experience objective can be based on an amount of tolerable error in executing the workload (e.g., to what extent processing deadlines must be met) and user experience expectations for particular use cases (e.g., for a particular use case, what QoS level is expected by the user). For example, where all frames of a workload must be rendered on time to meet a high QoS level expected for the workload, the priority level assigned to the workload corresponds to the QoS level needed to meet this user experience objective. In another example, where a lower QoS level is expected by the user, some amount of error in meeting processing deadlines can be tolerable. In such an example, a lower priority level can be assigned to the workload. As yet another example, where no user experience objective is associated with the workload an even lower priority level can be assigned to the workload. Further examples of priority levels and QoS levels for a user experience objective are provided below.

Consider an example where six job classes are employed and a policy includes a priority definition for each job class, where each priority definition corresponds to a distinct priority level. In this example, one job class is a ‘real-time critical’ job class. This job class corresponds to workloads that are critical to the functionality of a real-time application or service that cannot tolerate error. One or policies can indicate that workloads that fall into the real-time critical job class include, for example, video capture by a video recording application, audio capture by an audio recording application, wireless display rendering, and other workloads of real-time applications or services that require the highest level of QoS to meet a user experience objective. For example, a video capture workload by a video recording application, if not processed within a critical time period, will result in a video frame buffer being overwritten and thus an uncorrectable error in the video recording. At the same time, work items in a video capture, audio capture, or display rendering workload arrive at a regular cadence and consume a predictable amount of bandwidth. As such, the priority definition for the real-time critical job class assigns the highest priority level (e.g., priority level ‘1’) to workloads falling in this class. That is, workloads in the real-time critical job class should be provided with the highest priority access to hardware processing resources (e.g., video codecs, audio codecs, etc.) to provide the highest QoS level.

Continuing the above example, another job class is a ‘real-time high QoS’ job class. This job class corresponds to workloads that are necessary to the functionality of a real-time application or service that can tolerate a small amount of error. One or policies can indicate that workloads that fall into the real-time high QoS job class include, for example, video and/or audio playback by a multimedia application and other workloads of real-time applications or services that require a high, but not critical, QoS level. For example, a video playback workload by a multimedia application, if not processed quickly, will result in video playback glitch or stutter. While a user experience objective is to provide video playback that is free of glitch or stutter, a certain amount of error can be acceptable because often video playback is not a critical task. Accordingly, the priority definition for the real-time high QoS job class assigns the second highest priority level (e.g., priority level ‘2’) to workloads falling in this class.

Continuing the above example, another job class is a ‘real-time remote’ job class. This job class corresponds to workloads that are necessary to the functionality of a real-time application or service provided over a remote connection, such that some amount of error is expected by the user. One or policies can indicate that workloads that fall into the real-time high remote class include, for example, video conferencing, streaming media, and other workloads of real-time applications or services in which users understand, given communications bandwidth limitations, that QoS might degrade at points in time. For example, if the video feed temporarily freezes during a video teleconference, the user will expect that this is normal occurrence. Thus, such error a tolerable factor of the user experience objective. Accordingly, the priority definition for the real-time remote job class assigns the third highest priority level (e.g., priority level ‘3’) to workloads falling in this class.

Continuing the above example, another job class is a ‘low latency’ job class. This job class corresponds to workloads that are not real-time workloads but do require low latency to satisfy the user’s QoS expectation. One or policies can indicate that workloads that fall into the low latency job class include, for example, video game rendering and other workloads of non-real-time applications in which low latency is desirable but users are accustomed to irregularities in the rendering experience. For example, the graphics rendering time from one frame to the next is inconsistent and varies with respect to the computational complexity in rendering the frame. Thus, the user of a game application will expect that the user experience is not devoid of latency issues. Accordingly, the priority definition for the low latency job class assigns the fourth highest priority level (e.g., priority level '4') to workloads falling in this class.

Continuing the above example, another job class is a ‘normal’ or ‘default’ job class. This job class can correspond to workloads for which no use case, policy or priority definition exists. For example, the workload characterized as ‘normal’ or ‘default’ can be a new type of workload where the resource manager does not have policy for that type of workload, the application developer has failed to make the application compatible with the resource manager, or the application has failed to provide a description of the workload. In such an example, the resource manager does not need to associate a priority level with the workload. Rather, the workload is recognized as having the default fifth highest priority level (e.g., priority level '5').

Continuing the above example, another job class is a ‘background’ job class. This job class corresponds to workloads that should be prioritized behind all other workloads. One or policies can indicate that workloads that fall into the background job class include, for example, video transcoding, machine learning, and other computational workloads where there is little or no user experience except for the speed with which the workload is completed. That is, there is no real-time or continuous media experience. In one example, to expedite a video transcode workload it can be advantageous to place the video decode workload on the discrete GPU video codec and the video encode workload on the APU video codec, thus utilizing all of the accelerated video encoding and decoding capabilities of the computing system. However, in such a scenario, critical workloads such as display rendering should be given a priority higher than that of the transcode workloads. Thus, a background job can be allowed to use all of the available processing resources at a given time but only after all other workloads have been given priority access to those resources. Accordingly, the priority definition for the background job class assigns the lowest highest priority level (e.g., priority level '6') to workloads falling in this class.

In some implementations, a particular processing resource is reserved for particular job classes or priority levels. Workloads having a particular job class can be scheduled on these reserved resources, while workloads outside of that job class or job classes are not permitted to be scheduled on the reserved resources or may be preempted if executing on the reserved resources. Consider an example of a GPU with multiple SIMD pipelines. In an implementation where resources are reserved based on job class, the job schedule can reserve one or two SIMD pipelines for only real-time jobs (e.g., job class priority levels 1-3) when they are present. In this example, the job scheduler prevents non-real-time jobs from being scheduled on the reserved SIMD pipelines, or can allow non-real-time jobs to be scheduled and execute on the reserved SIMD pipelines but, when a real-time job is ready for scheduling, non-real-time jobs executing on the reserved SIMD pipelines are preempted in favor of the real-time job.

In some implementations, to prevent starvation where a low priority job waits infinitely in the queue, an aging mechanism is employed. When an aging mechanism is employed, the job scheduler tracks how long a job has been waiting on the queue and raises its priority as time goes by. For example, the priority level of a background job can be increased the longer the job waits in the queue for scheduling. In this way, the background job will eventually have a priority level that is high enough to allow it to be scheduled and/or to avoid preemption in favor of other jobs. In some cases, the job scheduler can employ aging only for particular job classes. For example, the job scheduler can employ aging for only non-real-time jobs (e.g., priority levels 4-6).

In this way, workloads are prioritized in their access to processing resources based on their workload types or job classifications in accordance with the level of user experience QoS a user would expect for that particular type of workload or job class. The job classes, workload types, and priority definitions discussed above are for illustration and should not be construed as limiting. Readers of skill in the art will appreciate that more or fewer job classes and priority definitions can be employed. For example, multiple job classes can share the same priority definition (i.e., the same priority level), and the number of priority definitions employed can be system or processing resource dependent.

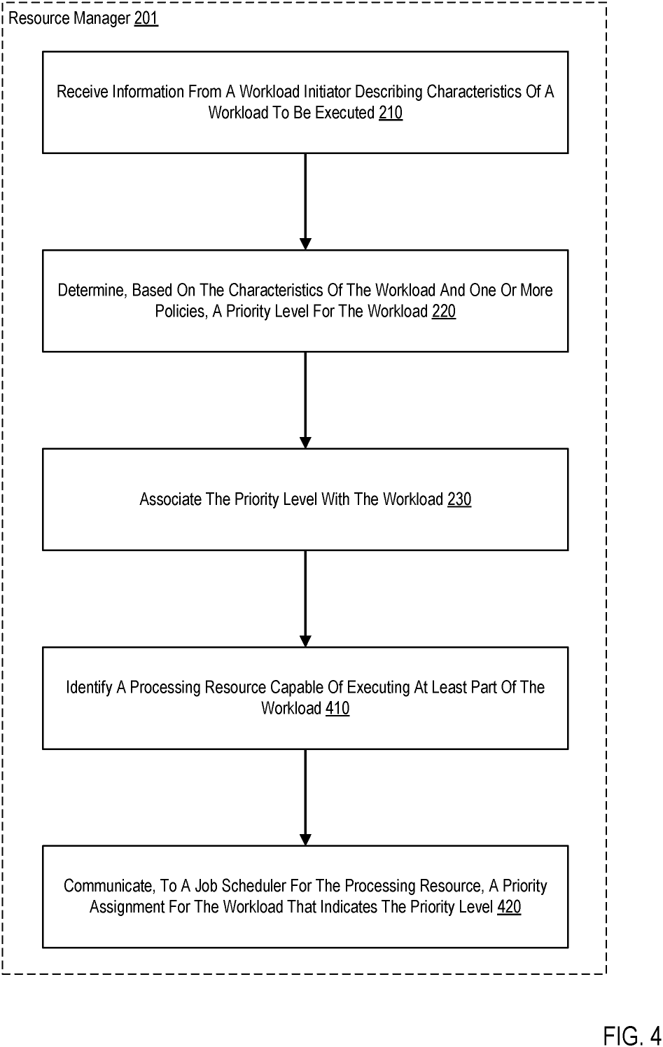

For further explanation, FIG. 4 sets forth a flow chart illustrating an example method of priority-based scheduling with limited resources in accordance with some implementations of the present disclosure. Like the example method of FIG. 2, the example method of FIG. 4 also includes receiving 210 information from a workload initiator describing characteristics of a workload to be executed; determining 220, based on the characteristics of the workload and one or more policies, a priority level for the workload; and associating 230 the priority level with the workload.

The example method of FIG. 4 also includes identifying 410 a processing resource capable of executing at least part of the workload. In some implementations, identifying 410 a processing resource capable of executing at least part of the workload is carried out by the resource manager 201 determining that a processing resource is capable of executing the workload or a portion of the workload. For example, the information describing the workload can indicate that the workload is media playback workload that includes a video decoding job, an audio decoding job, a composition job, and so on. The resource manager identifies from the information describing the workload that the workload requires H.264 video decoding in 4K resolution at 60 frames/second. The resource manager further identifies that a video codec on the discrete GPU is capable of handling this job.

The example method of FIG. 4 also includes communicating 420, to a job scheduler for the processing resource, a priority assignment for the workload that indicates the priority level. In some implementations, communicating 420, to the job scheduler for the processing resource, a priority assignment for the workload that indicates the priority level is carried out by the resource manager 201 communicating the priority level assignment for the workload to a job scheduler for the processing resource. In some variations, communicating the priority level assignment is carried out by indicating to the job scheduler a workload initiator ID (e.g., the process ID of the application or thread ID of the application thread) and the priority level determined for the workload. Continuing the above example, the resource manager can determine that the media playback workload falls within the real-time high QoS job class and thus has been assigned priority level '2.' The resource manager communicates the process ID of the media playback application in association with the priority level '2' to the job scheduler of the video codec on the discrete GPU. In this way, the job scheduler in the driver of the video codec on the discrete GPU recognizes that an incoming job from that process ID should be assigned a priority level of '2' and should be scheduled according to its priority handling mechanisms.

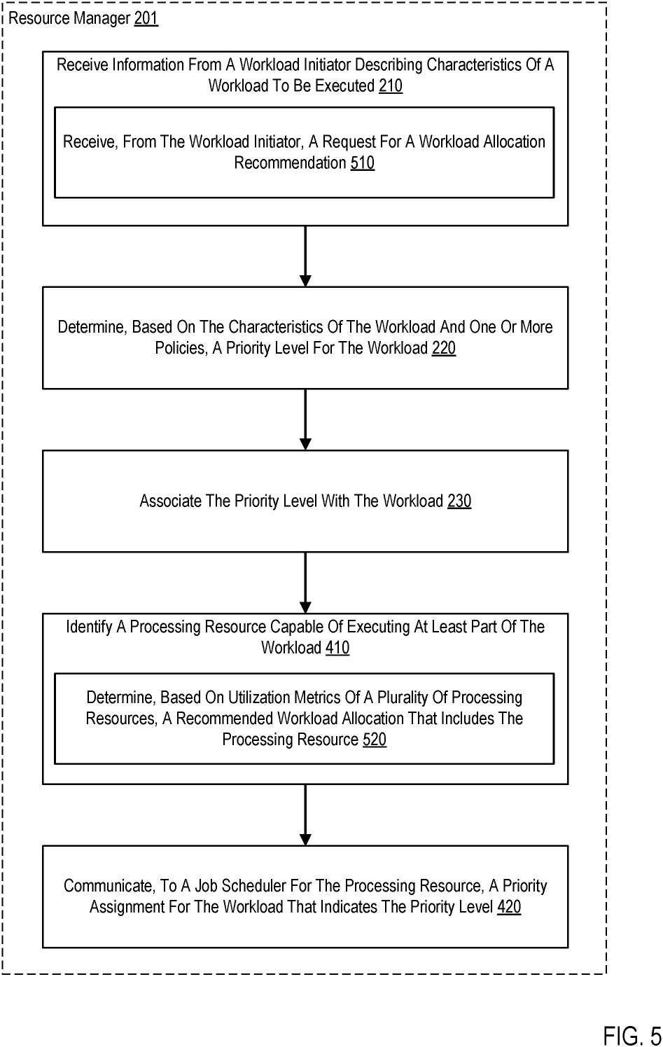

For further explanation, FIG. 5 sets forth a flow chart illustrating an example method of priority-based scheduling with limited resources in accordance with some implementations of the present disclosure. Like the example method of FIG. 4, the example method of FIG. 5 also includes receiving 210 information from a workload initiator describing characteristics of a workload to be executed; determining 220, based on the characteristics of the workload and one or more policies, a priority level for the workload; associating 230 the priority level with the workload; identifying 410 a processing resource capable of executing at least part of the workload; and communicating 420, to a job scheduler for the processing resource, a priority assignment for the workload that indicates the priority level.

In the example method of FIG. 5, receiving 210 information from a workload initiator describing characteristics of a workload to be executed includes receiving 510, from the workload initiator, a request for a workload allocation recommendation. In some implementations, receiving 510, from the workload initiator, the request for the workload allocation recommendation is carried out by the resource manager 201 receiving a query from a workload initiator application for advice as to where the workload should be placed among the processing resources capable of executing the workload. For example, the computing system (e.g., the system 100 of FIG. 1) can include multiple GPUs each having their own set GPU cores, accelerators, and other processing resources capable of executing the workload. In a particular example, the computing system includes an integrated GPU (e.g., the integrated GPU 104 of FIG. 1) and a discrete GPU (e.g., the discrete GPU 134 of FIG. 1). In such an example, the request from the workload initiator is a query to the resource manager as to whether the workload should be placed on the integrated GPU resources (e.g., shader cores and compute units, video and audio codecs, etc.) or the discrete GPU resources, or a combination thereof.

In some implementations, the resource manager exposes an API to applications on the computing system, where the API provides a mechanism for applications to submit information describing the workload (e.g., using the descriptor language discussed above), query the resource manager as to the processing resources that are available on the system, and request a recommendation for a workload allocation on those processing resources. For example, prior to deciding where to a submit a workload (e.g., on the integrated GPU resources or the discrete GPU resources), an application queries the resource manager for a recommended allocation for the workload.

In the example method of FIG. 5, identifying 410 a processing resource capable of executing at least part of the workload includes determining 520, based on utilization metrics of a plurality of processing resources, a recommended workload allocation that includes the processing resource. In some implementations, determining 520, based on utilization metrics of a plurality of processing resources, a recommended workload allocation that includes the processing resource is carried out by the resource manager 201 collecting values of runtime utilization metrics from the processing resources of, for example, the integrated GPU and the discrete GPU. For example, the processor resources can include GPU cores, multimedia accelerators such video codecs and audio codecs, display controllers, security processors, memory subsystems such as DMA engines and memory controllers, and bus interfaces such as a PCIe interface. The utilization of processor cores, multimedia accelerators, display controllers, security processors, and other processing units can be expressed by metrics such as a ratio of idle time to busy time. These components can include various counters for providing these metrics, which may be inspected via a call to a corresponding driver. Memory subsystem utilization can be expressed by metrics such as the number of read packets and the number of write packets issued over the interface within a current time period, the current utilization of ingress and egress queues or buffers, data transfer times and latency, and so on. Bus interface utilization can be expressed by metrics such as bandwidth. In particular, the utilization of the bus interface between the APU and the discrete GPU is important when a workload is split between the integrated GPU and the discrete GPU, such that the bandwidth of the bus interface poses a constraint on the ability of the integrated GPU and the discrete GPU to share result data. In some examples, obtaining values for the runtime metrics is carried out by the resource manager querying respective drivers of a plurality of processor resources to obtain the utilization metrics at runtime of the workload initiation.

In some implementations, determining 520, based on utilization metrics of a plurality of processing resources, a recommended workload allocation that includes the processing resource is also carried out by the resource manager 201 determining, based on the utilization of the processing resources, to which processing resource or combination of processing resources the workload can be allocated without oversubscribing those resources. The resource manager identifies possible workload allocations based on the requirements of the workload. For example, for a video decoding workload, the resource manager can identify that video codec of the integrated GPU and the video codec of the discrete GPU are both capable of implementing the video decoding protocol. Thus, the workload can be allocated to either the video codec of the integrated GPU and the video codec of the discrete GPU. For a particular workload allocation, and based on the values of the runtime utilization metrics and utilization profiles, the resource manager can predict an impact on the utilization of the processor resources in the proposed workload allocation. For example, the resource manager can predict, based on known utilization profile of an H.264 decode job, that the workload will increase utilization on a video codec by 30%. If the integrated GPU video codec is already at 80% utilization, adding the workload to the integrated GPU video codec will result in oversubscription of that resource. Thus, the resource manager identifies that placing the workload on the discrete GPU video codec is recommended. The workload allocation recommendation is then communicated to the workload initiator application so that the application can submit the workload to the recommended processing resource(s). The resource manager also signals to that recommended processing resource the priority level that has been assigned to the workload (i.e., by indicating the priority level and process ID of the workload initiator).

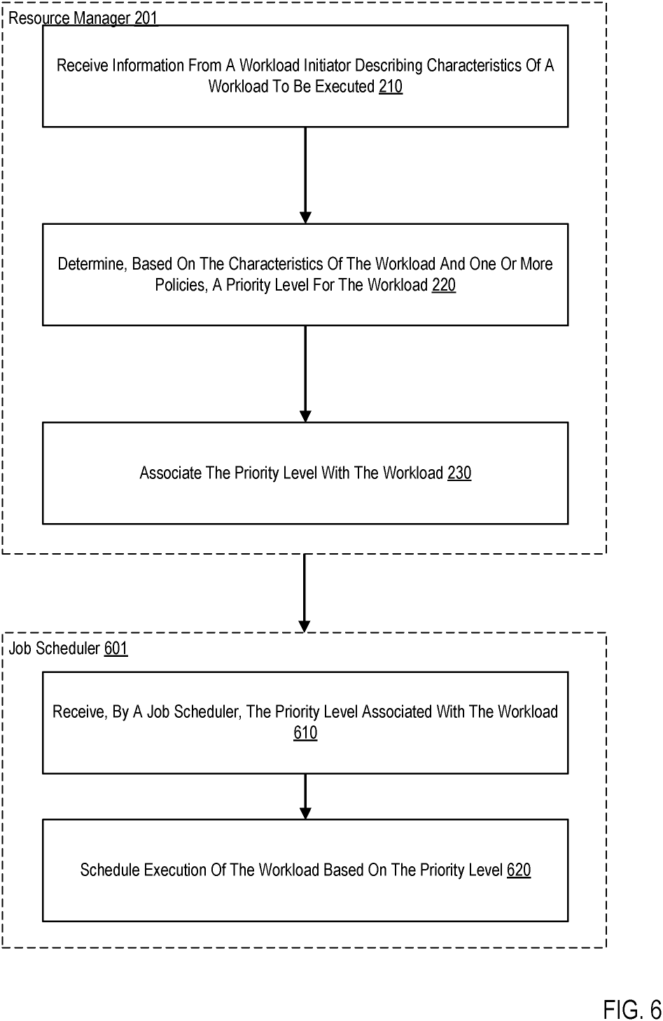

For further explanation, FIG. 6 sets forth a flow chart illustrating an example method of priority-based scheduling with limited resources in accordance with some implementations of the present disclosure. Like the example method of FIG. 2, the example method of FIG. 6 also includes receiving 210 information from a workload initiator describing characteristics of a workload to be executed; determining 220, based on the characteristics of the workload and one or more policies, a priority level for the workload; and associating 230 the priority level with the workload.

The example method of FIG. 6 also includes receiving 610, by a job scheduler, the priority level associated with the workload. As discussed above with reference to FIG. 1, in some implementations the job scheduler is implemented by the driver of the hardware resources (e.g., the video codec, audio codec, GPU cores, etc.). The resource manager communicates with the job scheduler directly (e.g., via an API or messaging) without reliance on the operating system for communication. In some implementations, receiving 610, by the job scheduler, the priority level associated with the workload is carried out by the job scheduler 601 (e.g., a job scheduler 194 in FIG. 1) receiving, from the resource manager 201, a priority assignment for a workload that includes an indication of a workload initiator identifier (e.g., a process or thread ID of a workload initiator) and a priority level. The job scheduler notates the priority assignment including an association between the workload initiator identifier and the priority level, for example, in a data structure. For example, the resource manager can assign a priority level '2' to a media playback workload initiated by a media playback application with a process ID of '1234.' The resource manager signals to the job scheduler of the video codec on the discrete GPU that a workload initiated by process ID '1234' should be assigned a priority level of '2'. The job scheduler of the video codec on the discrete GPU receives the priority assignment makes a notation that a workload initiated by process ID 1234 should be scheduled as priority level '2' workload.

The example method of FIG. 6 also includes scheduling 620 execution of the workload based on the priority level. In some implementations, scheduling 620 execution of the workload based on the priority level is carried out by the job scheduler 601 inspecting the workload initiator identifier of each incoming workload and determining whether that workload initiator identifier corresponds to a previously notated priority assignment. Continuing the above example, when the job scheduler receives a workload (i.e., the media playback workload) having the process ID '1234', the job scheduler refers to a priority assignment index to determine whether a priority level has been associated with the process ID '1234.' Upon determining that the job scheduler has a record indicating that a workload initiated by process ID 1234 should be scheduled as priority level '2' workload, the job scheduler schedules that workload according to a scheduling policy for priority level '2' workloads. In some implementations, the scheduling policy dictates that the media playback workload having a priority level '2' is provided access to the video decoding resources ahead of all lower priority workloads that are pending or that are subsequently received.

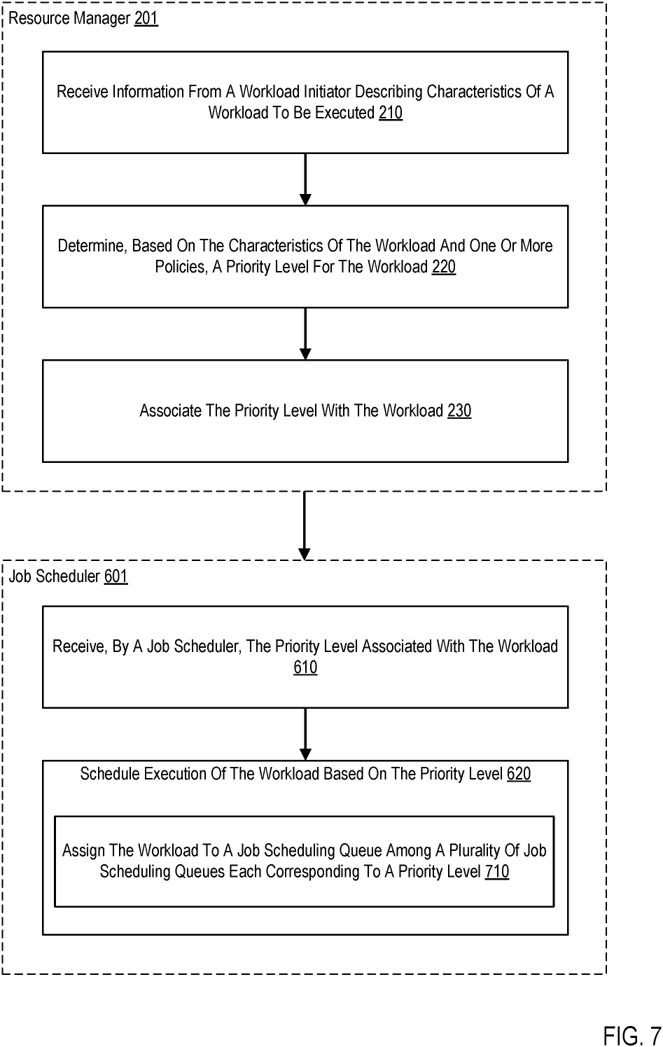

For further explanation, FIG. 7 sets forth a flow chart illustrating an example method of priority-based scheduling with limited resources in accordance with some implementations of the present disclosure. Like the example method of FIG. 6, the example method of FIG. 7 also includes receiving 210 information from a workload initiator describing characteristics of a workload to be executed; determining 220, based on the characteristics of the workload and one or more policies, a priority level for the workload; associating 230 the priority level with the workload; receiving 610, by a job scheduler, the priority level associated with the workload; and scheduling 620 execution of the workload based on the priority level.

In the example method of FIG. 7, scheduling 620 execution of the workload based on the priority level includes assigning 710 the workload to a job scheduling queue among a plurality of job scheduling queues each corresponding to a priority level. In some implementations, assigning 710 the workload to a job scheduling queue among a plurality of job scheduling queues each corresponding to a priority level is carried out by maintaining a set of job queues where each job queue corresponds to a priority level and associating a workload with a job queue based on the priority level assigned to the workload and the priority level defined for the job queue. In some variations, associating a workload with a job queue is carried out by the job scheduler 601 identifying a workload initiator identifier of a workload, determining a priority level associated with the workload initiator identifier, identifying a job queue that is defined for that priority level, and then associating the workload with the job queue by inserting each work item of the workload into that job queue. Continuing the above example, when the job scheduler receives the workload associated with the process ID '1234,' the job scheduler determines that process ID '1234' has been assigned a priority level of ‘2.’ The job scheduler then inserts work items for that workload into a job queue that is defined for workloads having a priority level '2.' The job scheduler can implement a variety of priority scheduling policies to service the different priority job queues. For example, the job scheduler can select work items for execution from the job queue defined for priority level ‘1’ workloads before selecting work items from the priority level '2' job queue, and then select work items for execution from the priority level '2' job queue before selecting work items from the priority level '3' job queue, and so on. Thus, a background class workload having a lowest priority level of '6' will only have access to hardware processing resources when no other higher priority workload requires them. In some implementations, the preemption privilege can be limited to real-time jobs only (e.g., priority levels 1-3). For example, when a hardware processing core is servicing a non-real-time job, it can service the running job until completion or another until real-time job arrives.

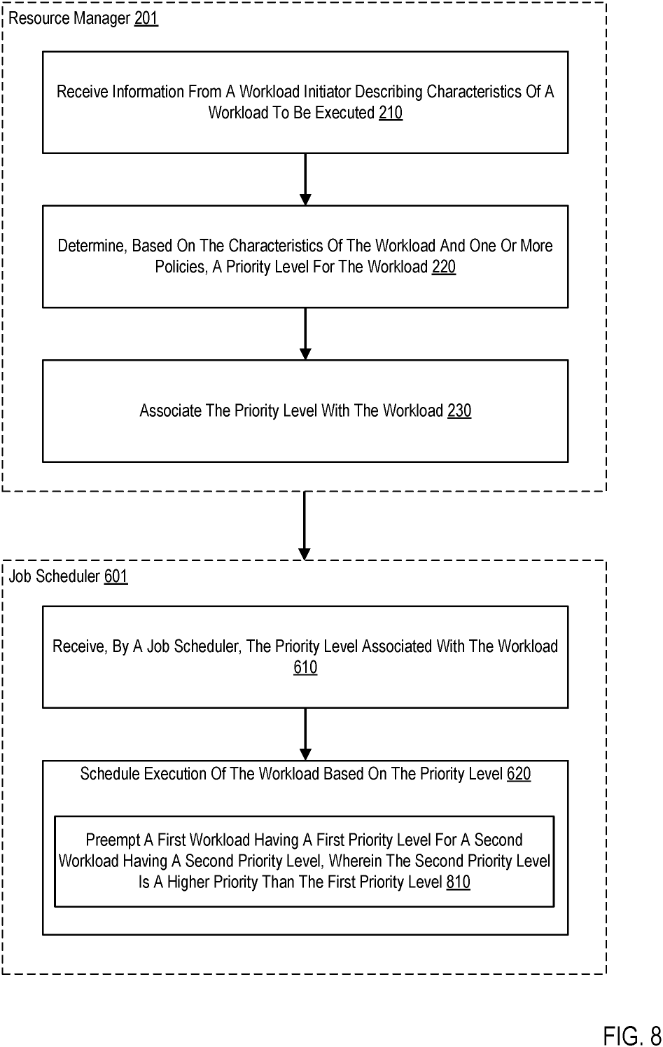

For further explanation, FIG. 8 sets forth a flow chart illustrating an example method of priority-based scheduling with limited resources in accordance with some implementations of the present disclosure. Like the example method of FIG. 6, the example method of FIG. 8 also includes receiving 210 information from a workload initiator describing characteristics of a workload to be executed; determining 220, based on the characteristics of the workload and one or more policies, a priority level for the workload; associating 230 the priority level with the workload; receiving 610, by a job scheduler, the priority level associated with the workload; and scheduling 620 execution of the workload based on the priority level.

In the example method of FIG. 8, scheduling 620 execution of the workload based on the priority level includes preempting 810 a first workload having a first priority level for a second workload having a second priority level, wherein the second priority level is a higher priority than the first priority level. In some implementations, preempting 810 a first workload having a first priority level for a second workload having a second priority level is carried out by the job scheduler 601 determining, while dispatching work items from a lower priority job, that a higher priority job has been received. When the job scheduler detects the higher priority workload, the job scheduler pauses processing work items for the low priority workload and begins dispatching work items of the higher priority workload. Consider an example where a job scheduler for a video codec is processing work items from a transcoding workload (i.e., the background job class) having the lowest priority level and the job scheduler receives a video capture workload having the highest priority level. The job scheduler pauses the dispatch of the transcoding work items to the video codec and begins dispatching video capture work items to the video codec.

In view of the foregoing, readers of skill in the art will appreciate that implementations in accordance with the present disclosure offer a number of advantages. For example, these implementations provide a mechanism for prioritizing workloads based on the user’s expectation of service quality. A resource manager can assign priority based on a description of the workload as well as policies that govern workload use cases and priority definitions. The workload use cases and their corresponding priority definitions can be based on the quality of service that is expected for that use case. The classification of workloads based on use cases and user experience expectations allows workloads to be associated with priority levels, and those workloads can receive access to hardware resources in accordance with that priority assignment. A job scheduler for a hardware processing resource that receives the priority assignments from the resource manager can schedule the workload for execution on the hardware resource in accordance with the priority assignment. Job schedulers for hardware resources can receive workload priority assignments in advance of receiving the workload, such that the job scheduler can implement the priority-based scheduling upon workload arrival. Priority assignments based on use cases are advantageous to guarantee a QoS level and a user experience that is expected for the use case, while balancing this expected QoS level with the hardware needs of higher priority workloads. In this way, the user experience and expected performance of the application can be improved by scheduling workloads in accordance with an expected user experience.

Exemplary implementations of the present disclosure are described largely in the context of a fully functional processing system for priority-based scheduling with limited resources. Readers of skill in the art will recognize, however, that implementations of the present disclosure also can be embodied in a computer program product disposed upon computer readable storage media for use with any suitable data processing system.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some implementations, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the present disclosure. It will be understood that each block of the flowchart illustrations and/or block diagrams, and combinations of blocks in the flowchart illustrations and/or block diagrams, can be implemented by computer readable program instructions.

The flowchart and block diagrams in the figures illustrate the architecture, functionality, and operation of possible implementations of systems, methods, and computer program products according to various implementations of the present disclosure. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes can be made in various implementations of the present disclosure without departing from its true spirit. The descriptions in this specification are for purposes of illustration only and are not to be construed in a limiting sense. The scope of the present disclosure is limited only by the language of the following claims.

What is claimed is:

1. A method of priority-based scheduling with limited resources, the method comprising:
receiving information from a workload initiator describing characteristics of a workload to be executed;
determining, based on the characteristics of the workload and one or more policies, a priority level for the workload; and
associating the priority level with the workload.

2. The method of claim 1, wherein the priority level corresponds to one or more quality of service (QoS) levels based on a user experience objective.

3. The method of claim 1, wherein determining, based on the characteristics of the workload and one or more policies, a priority level for the workload includes:
identifying, based on the characteristics of the workload, a job classification for the workload; and
identifying, from the one or more policies, a priority definition corresponding to the job classification.

4. The method of claim 1 further comprising:
identifying a processing resource capable of executing at least part of the workload; and
communicating, to a job scheduler for the processing resource, a priority assignment for the workload that indicates the priority level.

5. The method of claim 4, wherein the processing resource is a decoding/encoding accelerator.

6. The method of claim 4, wherein receiving information from a workload initiator describing characteristics of a workload to be executed includes:
receiving, from the workload initiator, a request for a workload allocation recommendation; and
wherein identifying a processing resource capable of executing at least part of the workload includes:
determining, based on utilization metrics of a plurality of processing resources, a recommended workload allocation that includes the processing resource.

7. The method of claim 1 further comprising:
receiving, by a job scheduler, the priority level associated with the workload; and
scheduling execution of the workload based on the priority level.

8. The method of claim 7, wherein scheduling execution of the workload based on the priority level includes:
assigning the workload to a job scheduling queue among a plurality of job scheduling queues each corresponding to a priority level.

9. The method of claim 7, wherein scheduling execution of the workload based on the priority level includes:
preempting a first workload having a first priority level for a second workload having a second priority level, wherein the second priority level is a higher priority than the first priority level.

10. An apparatus for priority-based scheduling with limited resources, the apparatus comprising a computer processor, a computer memory operatively coupled to the computer processor, the computer memory having disposed therein computer program instructions that, when executed by the computer processor, cause the apparatus to carry out the steps of:
receiving information from a workload initiator describing characteristics of a workload to be executed;
determining, based on the characteristics of the workload and one or more policies, a priority level for the workload; and
associating the priority level with the workload.

11. The apparatus of claim 10, wherein the priority level corresponds to one or more quality of service (QoS) levels based on a user experience objective.

12. The apparatus of claim 10, wherein determining, based on the characteristics of the workload and one or more policies, a priority level for the workload includes:
identifying, based on the characteristics of the workload, a job classification for the workload; and
identifying, from the one or more policies, a priority definition corresponding to the job classification.

13. The apparatus of claim 10 further comprising computer program instructions that, when executed, cause the apparatus to carry out the steps of:
identifying a processing resource capable of executing at least part of the workload; and
communicating, to a job scheduler for the processing resource, a priority assignment for the workload that indicates the priority level.

14. The apparatus of claim 10 further comprising computer program instructions that, when executed, cause the apparatus to carry out the steps of:
receiving, by a job scheduler, the priority level associated with the workload; and
scheduling execution of the workload based on the priority level.

15. The apparatus of claim 14, wherein scheduling execution of the workload based on the priority level includes:
assigning the workload to a job scheduling queue among a plurality of job scheduling queues each corresponding to a priority level.

16. A computer program product for priority-based scheduling with limited resources, the computer program product disposed upon a computer readable storage medium, the computer program product comprising computer program instructions that, when executed, cause a computer to carry out the steps of:
receiving information from a workload initiator describing characteristics of a workload to be executed;
determining, based on the characteristics of the workload and one or more policies, a priority level for the workload; and
associating the priority level with the workload.

17. The computer program product of claim 16, wherein determining, based on the characteristics of the workload and one or more policies, a priority level for the workload includes:
identifying, based on the characteristics of the workload, a job classification for the workload; and
identifying, from the one or more policies, a priority definition corresponding to the job classification.

18. The computer program product of claim 16 further comprising computer program instructions that, when executed, cause the computer to carry out the steps of:
identifying a processing resource capable of executing at least part of the workload; and
communicating, to a job scheduler for the processing resource, a priority assignment for the workload that indicates the priority level.

19. The computer program product of claim 16 further comprising computer program instructions that, when executed, cause the computer to carry out the steps of:
receiving, by a job scheduler, the priority level associated with the workload; and
scheduling execution of the workload based on the priority level.

20. The computer program product of claim 19, wherein scheduling execution of the workload based on the priority level includes:
assigning the workload to a job scheduling queue among a plurality of job scheduling queues each corresponding to a priority level.
